(19) United States
(12) Patent Application Publication
(10) Pub. No.: US 2025/0106670 A1
(43) Pub. Date: Mar. 27, 2025

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/894,023

(22) Filed: Sep. 24, 2024

(30) Foreign Application Priority Data
Sep. 25, 2023 (CN) 202311244657.8

(51) Int. Cl. H04W 24/10; H04W 36/00

(52) U.S. Cl. CPC H04W 24/10; H04W 36/0085

(57) ABSTRACT

The present application discloses a method and a device used for wireless communications, including executing a first signaling, the first signaling configuring a target SpCell; transmitting a first message as a response to successfully executing the first signaling, the first message indicating completion of an RRC reconfiguration; and transmitting a first report, the first report comprising information of a successful switch; the information of the successful switch comprises at least a former of a first measurement result and a second measurement result, the first measurement result and the second measurement result being both for a source cell; where the first measurement result is a most recent measurement result before executing the first signaling, while the second measurement result is a most recent measurement result before transmitting the first message. This application provides better network optimization.

### CROSS REFERENCE TO RELATED APPLICATIONS

This application claims the priority benefit of Chinese Patent Application No. 202311244657.8, filed on Sep. 25, 2023, the full disclosure of which is incorporated herein by reference.

### BACKGROUND

### Technical Field

The present application relates to transmission methods and devices in wireless communication systems, which relate to the problems in switching and measurement.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Terrestrial Network (TN), Dual connectivity system, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

Refer to 3GPP specifications for the concepts, terminology and abbreviations given in the present application, including but not limited to:
https://www.3gpp.org/ftp/Specs/archive/21_series/21.905/21905-h10.zip
https://www.3gpp.org/ftp/Specs/archive/38_series/38.300/38300-h10.zip
https://www.3gpp.org/ftp/Specs/archive/38_series/38.331/38331-h10.zip
https://www.3gpp.org/ftp/Specs/archive/38_series/38.321/38321-h10.zip
https://www.3gpp.org/ftp/Specs/archive/38_series/38.133/38133-h10.zip

### SUMMARY

The researchers found that in the scenario of sending information about successful switching, how to send measurement results that are more useful for network optimization is a problem that needs to be solved. The researchers further found that in order to perform network optimization and optimize switching, a terminal may report information about successful switching after being successfully switched, and this information may include some measurement results for the network to optimize switching and grasp the network conditions, and the measurement results included in the information about successful switching, such as the measurement results for the source cell, are helpful for the network to understand the quality of the source cell, but not arbitrary measurement results, such as arbitrary measurement results for the source cell, are similarly beneficial for network optimization. For example, the results that have a key impact on the switching performance, including the quality of the source cell at the time of triggering the switching, play an important role in network optimization, and the network can know whether the switching of the terminal occurs at the right time through the results of the measurements. However, by reporting measurement results arbitrarily, for example, long after the switchover has been triggered, the network will not know exactly what the measurement results mean and what may interfere with the network's decision making, so how to make the measurement results in the information of successful switching more relevant and valuable is a problem that needs to be solved. The researchers further found that despite successful switching, the switching itself still has areas that can be optimized, for example, switching too late may cause degradation of communication quality, so how to trigger the switching at the best possible time still needs to be optimized, for example, the design of timers can be further optimized, or timers for link failure of the radio link, for example, timers for in-switching, and so on, for example, how to leverage the use of artificial intelligence to achieve better switching performance.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Besides, the method proposed in the present application can also be used for addressing other issues confronting communications, such as those in NR Evolution and 6G system, and this application is applicable for many kinds of 3GPP-based communication networks.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
executing a first signaling, the first signaling configuring a target Special Cell (SpCell);
transmitting a first message as a response to successfully executing the first signaling, the first message indicating completion of a Radio Resource Control (RRC) reconfiguration; and
transmitting a first report, the first report comprising information of a successful switch; the information of the successful switch comprising at least a former of a first measurement result and a second measurement result, the first measurement result and the second measurement result being both for a source cell;
herein, the first measurement result is a most recent measurement result before executing the first signaling, while the second measurement result is a most recent measurement result before transmitting the first message.

In one embodiment, a problem to be solved in the present application includes: how to carry more valuable measurement results via the information of successful switching.

In one embodiment, an advantage of the above method includes: enabling better optimization of switching, better network optimization, avoiding interruption of communication, ensuring switching performance, as well as offering better support for artificial intelligence-based switching methods, and better support for condition-based switching, and improving both network performance and quality of service of the network.

Specifically, according to one aspect of the present application, whether the information of the successful switch comprises the second measurement result depends on the first signaling.

Specifically, according to one aspect of the present application, the information of the successful switch comprises a third measurement result and a fourth measurement result, the third measurement result and the fourth measurement result being both for the target SpCell:
herein, the third measurement result is a most recent measurement result before executing the first signaling, while the fourth measurement result is a most recent measurement result before transmitting the first message.

Specifically, according to one aspect of the present application, the information of the successful switch indicates time for at least one measurement result.

Specifically, according to one aspect of the present application, the executing of the first signaling depends on a first measurement event being satisfied.

Specifically, according to one aspect of the present application, receiving a second signaling, the second signaling triggering the action of executing the first signaling, the second signaling being a control signaling at a MAC layer, the second signaling indicating the target SpCell.

Specifically, according to one aspect of the present application, the executing of the first signaling depends on an output by a first generator, the first generator being training-based.

Specifically, according to one aspect of the present application, the information of the successful switch indicates that the first measurement result is a measurement result before executing the first signaling.

Specifically, according to one aspect of the present application, the information of the successful switch comprises at least a former of a fifth measurement result and a sixth measurement result, the fifth measurement result and the sixth measurement result being both for a first reference signal resource for the source cell:
herein, the fifth measurement result is a most recent measurement result before executing the first signaling, while the sixth measurement result is a most recent measurement result before transmitting the first message.

Specifically, according to one aspect of the present application, the first node is a terminal of Internet of Things (IoT).

Specifically, according to one aspect of the present application, the first node is a UE.

Specifically; according to one aspect of the present application, the first node is an access-network device.

Specifically, according to one aspect of the present application, the first node is a vehicle-mounted terminal.

Specifically; according to one aspect of the present application, the first node is a cellphone.

Specifically, according to one aspect of the present application, the first node supports multiple SIMs.

The present application provides a first node for wireless communications, comprising:
a first processor, executing a first signaling, the first signaling configuring a target SpCell; and
a first transmitter, transmitting a first message as a response to successfully executing the first signaling, the first message indicating completion of an RRC reconfiguration; and
the first transmitter, transmitting a first report, the first report comprising information of a successful switch; the information of the successful switch comprising at least a former of a first measurement result and a second measurement result, the first measurement result and the second measurement result being both for a source cell;
herein, the first measurement result is a most recent measurement result before executing the first signaling, while the second measurement result is a most recent measurement result before transmitting the first message.

In one embodiment, compared with the prior art, the present application is advantageous in the following aspects:

The first measurement result included in the information of successful switch is more targeted and more direct and clearer for network optimization.

For evolved cell handover, such as artificial intelligence-based cell handover, the terminal can determine the timing of the switching to a certain extent, at which point the network is unable to accurately grasp the quality of the wireless channel at the time of triggering the switching, and thus is unable to accurately assess the network performance and improve the switching, whereas the method proposed in the present application is conducive to the network understanding the quality of the wireless channel at the time of triggering the switching, hence avoidance of the above problem.

The first measurement result and the second measurement result included in the information of successful switch are beneficial for the network's grasp of the quality of the radio link before and after being switched, and thus the complete switching procedure can be grasped, which is very helpful both for the optimization of the switching and for the optimization of the network.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of executing a first signaling, transmitting a first message and transmitting a first report according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of switching according to one embodiment of the present application.

FIG. 7 illustrates a schematic diagram of whether the information of successful switch comprises a second measurement result depending on a first signaling according to one embodiment of the present application.

FIG. 8 illustrates a schematic diagram of the executing of a first signaling depending on an output by a first generator according to one embodiment of the present application.

FIG. 9 illustrates a schematic diagram of the information of successful switch indicating that a first measurement result is a measurement result before executing a first signaling according to one embodiment of the present application.

FIG. 10 illustrates a structure block diagram of a processing device in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

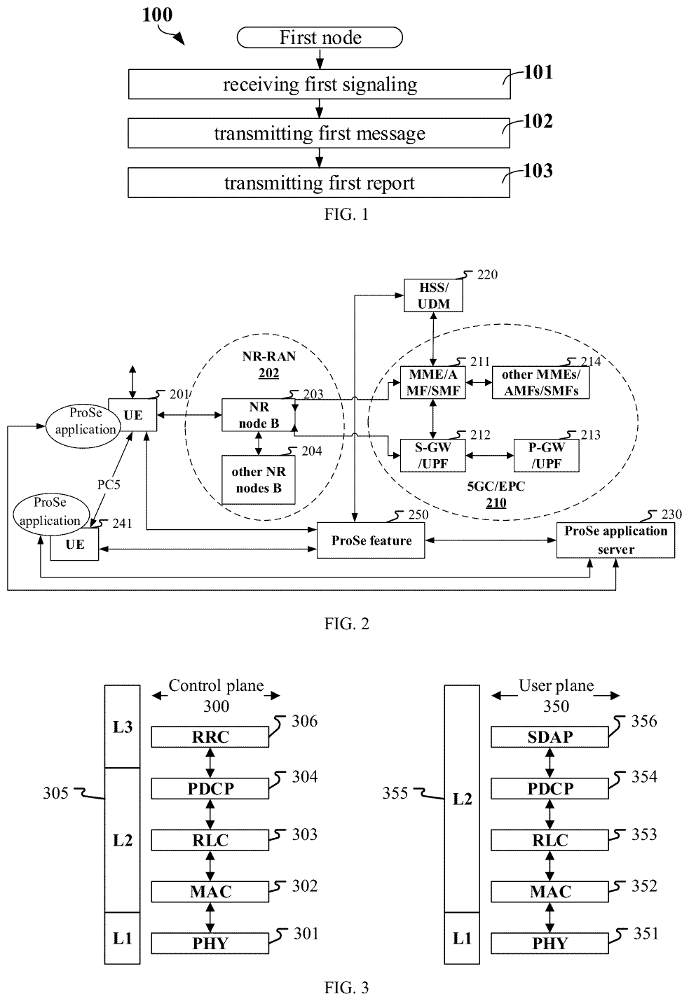

Embodiment 1 illustrates a flowchart of executing a first signaling, transmitting a first message and transmitting a first report according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application executes a first signaling in step 101; and transmits a first message in step 102; and transmits a first report in step 103:
herein, the first signaling configures a target SpCell: the step 102 is executed as a response to successfully executing the first signaling, the first message indicating completion of an RRC reconfiguration; the first report comprises information of a successful switch: the information of the successful switch comprising at least a former of a first measurement result and a second measurement result, the first measurement result and the second measurement result being both for a source cell: the first measurement result is a most recent measurement result before executing the first signaling, while the second measurement result is a most recent measurement result before transmitting the first message.

In one embodiment, the first node is a User Equipment (UE).

In one embodiment, the first node is in an RRC connected state.

In one embodiment, any parameter in the present application is either configured by the network or may be generated by the first node according to an internal algorithm, e.g. randomization.

In one embodiment, the value of any parameter in this application, including, but not limited to, the value of a timer or the value of a counter, unless specifically stated, is limited.

In one subembodiment, an upper limit of the value of any parameter in this application is 1024 times 65536.

In one subembodiment, an upper limit of the value of any parameter in this application is 65536 or 65535.

In one subembodiment, an upper limit of the value of any parameter in this application is 1024.

In one subembodiment, an upper limit of the value of any parameter in this application is 640 or 320.

In one embodiment, the present application is for NR.

In one embodiment, the present application is for wireless communication networks after NR.

In one embodiment, a serving cell refers to a cell that the UE is camped on. Performing cell search includes that the UE searches for a suitable cell for a selected Public Land Mobile Network (PLMN) or Stand-alone Non-Public Network (SNPN), selects the suitable cell to provide available services, and monitors a control channel of the suitable cell, where the whole procedure is defined to be camped on the cell: in other words, relative to this UE, the cell being camped on is seen as a serving cell of the UE. Camping on a cell in either RRC_Idle state or RRC_Inactive state has the following benefits: it allows the UE to receive system messages from the PLMN or SNPN: when registered, if the UE wishes to establish an RRC connection or continue a suspending RRC connection, the UE can do so by performing an initial access on the control channel of the camped cell: the network can page the UE: it allows the UE to receive Earthquake and Tsunami Warning System (ETWS) and Commercial Mobile Alert System (CMAS) notifications.

In one embodiment, for a UE in RRC connected state without being configured with carrier aggregation/dual connectivity (CA/DC), there is only one serving cell that comprises a primary cell. For a UE in RRC connected state that is configured with carrier aggregation/dual connectivity (CA/DC), a serving cell is used for indicating a cell set comprising a Special Cell (SpCell) and all secondary cells. A Primary Cell is a cell in a Master Cell Group (MCG), i.e., an MCG cell, working on the primary frequency, and the UE performs an initial connection establishment procedure or initiates a connection re-establishment on the Primary Cell. For dual connectivity (DC) operation, a special cell refers to a Primary Cell (PCell) in an MCG or a Primary SCG Cell (PSCell) in a Secondary Cell Group (SCG): otherwise, the special cell refers to a PCell.

In one embodiment, working frequency of a Secondary Cell (SCell) is secondary frequency:

In one embodiment, separate contents in information elements (IEs) are referred to as fields.

In one embodiment, Multi-Radio Dual Connectivity (MR-DC) refers to dual connectivity with an E-UTRA node and an NR node, or with two NR nodes.

In one embodiment, in MR-DC, a radio access node providing a control plane connection to the core network is a master node, where the master node can be a master eNB, a master ng-eNB or a master gNB.

In one embodiment, an MCG refers to a group of serving cells associated with a master node in MR-DC, including a SpCell, and optionally, one or multiple SCells.

In one embodiment, a PCell is a SpCell of an MCG.

In one embodiment, a PSCell is a SpCell of an SCG.

In one embodiment, in MR-DC, a radio access node not providing a control plane connection to the core network but providing extra resources for the UE is a secondary node. The secondary node can be an en-gNB, a secondary ng-eNB or a secondary gNB.

In one embodiment, in MR-DC, a group of serving cells associated with a secondary node is a secondary cell group (SCG), including a SpCell and, optionally, one or multiple SCells.

In one embodiment, the SpCell is a PCell or the SpCell is a PSCell.

In one embodiment, an RRC information block refers to an information block (information element) in an RRC message.

In one embodiment, an SSB may be referred to as an SS\PBCH, or SS block.

In one embodiment, L1 is Layer-1 or the physical layer.

In one embodiment, the method proposed in the present application is particularly applicable for the case where the first node is only configured with a master cell group (MCG).

In one embodiment, the first node is only configured with an MCG in a network where the receiver of the first UE assistance information is present.

In one embodiment, the first node is not configured with an SCG in a network where a receiver of the first UE assistance information is present.

In one embodiment, the first node is configured with DC.

In one embodiment, the first node supports multi-SIM communication.

In one embodiment, the SIM comprises a Universal Subscriber Identity Module (USIM).

In one embodiment, the first node supports Multi-Universal Subscriber Identity Module (MUSIM) communication.

In one embodiment, the first node uses MUSIM features.

In one embodiment, an RRC information block may include one or more RRC information blocks.

In one embodiment, an RRC information block does not have to include any RRC information block, but only includes at least one parameter.

In one embodiment, radio bearers include at least a signaling radio bearer and a data radio bearer.

In one embodiment, the radio bearer is services or an interface of services provided by the PDCP layer to higher layers.

In one subembodiment, the higher layers include one of an RRC layer, a NAS and a SDAP layer.

In one embodiment, a signaling radio bearer is services or an interface of services provided by the PDCP layer to higher layers.

In one subembodiment, the higher layers include at least the former of an RRC layer and a NAS.

In one embodiment, a data radio bearer is services or an interface of services provided by the PDCP layer to higher layers.

In one subembodiment, the higher layers include at least the former of a SDAP layer and a NAS

In one embodiment, the first signaling is an RRC signaling.

In one embodiment, the first signaling is an RRCReconfiguration.

In one embodiment, the first signaling is RRC reconfigured.

In one embodiment, the first signaling is an information block carried by an RRC reconfiguration signaling.

In one embodiment, the first signaling is another RRC reconfiguration carried by the RRC reconfiguration signaling.

In one embodiment, the first signaling is an RRCReconfiguration in the RRCReconfiguration.

In one embodiment, a generator of the first signaling is a source cell of the first node.

In one embodiment, a generator of the first signaling is a target cell of the first node.

In one subembodiment, the first signaling is a conditional RRC reconfiguration.

In one embodiment, the first signaling is transmitted via SRB1.

In one embodiment, the first signaling is a downlink signaling.

In one embodiment, when the first signaling is a conditional reconfiguration, the first signaling is executed upon satisfaction of a first measurement event; otherwise, the first signaling is executed immediately upon reception.

In one embodiment, whether the first signaling is executed immediately upon reception depends on whether an execution condition is associated.

In one subembodiment, the execution condition comprises the fulfillment of a certain measurement event.

In one embodiment, receiving a signaling is prior art in this field.

In one embodiment, the event in this field refers specifically to a report type commonly used to trigger a measurement report, unlike a periodic report, an event-triggered report triggers a corresponding reporting behavior only when the entry conditions for the event are met, the types of events are limited and predefined, and the parameters of each event are configurable, for example an Event A1 indicates that a serving cell is better than a given threshold, the given threshold being a parameter of this event.

In one embodiment, the first measurement event is a conditional event, for example CondEvent.

In one embodiment, the executing of the first signaling depends on a first measurement event being satisfied.

In one subembodiment, the first measurement event is one of or a combination of multiple of CondEvent A3, CondEvent A4, CondEvent A5, CondEvent T1, and CondEvent L1.

In one embodiment, the target SpCell is a switched target SpCell.

In one embodiment, the target SpCell is a target PCell.

In one embodiment, the meaning of the phrase the first signaling configuring a target SpCell is or includes: the first signaling comprising spCellConfig.

In one subembodiment, the spCellConfig comprises synchronized reconfiguration.

In one subembodiment, the spCellConfig comprises reconfiguration WithSync.

In one embodiment, the meaning of the phrase the first signaling configuring a target SpCell is or includes: configuring a Cell-Radio Network Temporary Identifier (C-RNTI) of the first node in the target SpCell.

In one embodiment, the meaning of the phrase the first signaling configuring a target SpCell is or
includes: configuring a first cell group, a SpCell of the first cell group being the target SpCell.

In one subembodiment, the first cell group is an MCG.

In one subembodiment, the first cell group is an SCG.

In one subembodiment, CellGroupConfig included in the first signaling configures the first cell group.

In one embodiment, a cell group to which the target SpCell belongs is a first cell group.

In one embodiment, the meaning of the phrase the first signaling configuring a target SpCell is or includes: configuring a frequency of the target SpCell.

In one embodiment, the meaning of the phrase the first signaling configuring a target SpCell is or includes: configuring an identity of the target SpCell.

In one embodiment, the meaning of the phrase the first signaling configuring a target SpCell is or
includes: carrying a broadcast information block of the target SpCell.

In one embodiment, the meaning of the phrase the first signaling configuring a target SpCell is or includes: configuring at least one timer of the target SpCell.

In one subembodiment, the at least one timer includes T304.

In one subembodiment, the at least one timer includes T310.

In one subembodiment, the at least one timer includes T311.

In one subembodiment, the at least one timer includes T301.

In one embodiment, when the first signaling is successfully executed, the target SpCell becomes a SpCell of the first node.

In one embodiment, when the first signaling is successfully executed, the first node switches to the target SpCell.

In one embodiment, the switching in this application comprises at least one of cell handover and cell switch.

In one embodiment, the switching in this application is or includes conditional handover (CHO).

In one embodiment, the action of executing the first signaling comprises performing each configuration of the first signaling.

In one embodiment, the action of executing the first signaling comprises executing each information block of the first signaling.

In one embodiment, the action of executing the first signaling comprises applying each parameter of the first signaling.

In one embodiment, the action of executing the first signaling comprises: synchronizing to the target SpCell.

In one embodiment, the action of executing the first signaling comprises: resetting the MAC of a cell group to which the target SpCell belongs.

In one embodiment, the action of executing the first signaling comprises: applying a C-RNTI configured by the first signaling in a cell group to which the target SpCell belongs.

In one embodiment, the action of executing the first signaling comprises: configuring a lower layer according to the first signaling.

In one embodiment, the action of executing the first signaling comprises: obtaining a master information block (MIB) of the target SpCell.

In one embodiment, the action of executing the first signaling comprises: applying a broadcast control channel (BCCH) configuration for the target SpCell.

In one embodiment, the execution of the first signaling comprises applying the target SpCell configured by the first signaling, i.e., the target SpCell becoming a SpCell of the first node.

In one subembodiment, the above behavior is switching.

In one embodiment, the T304 timer is started upon reception of the first signaling.

In one embodiment, the T304 timer is started upon execution of the first signaling.

In one embodiment, the T304 timer is stopped upon successful completion of a random access for the target SpCell.

In one embodiment, the expiration of the T304 timer triggers an RRC connection re-establishment.

In one embodiment, the T301 timer is started when an RRC re-establishment request is transmitted and is stopped when an RRC re-establishment signaling is received, and the expiration of the T301 timer triggers entry into RRC idle state.

In one embodiment, the T311 timer is started when an RRC connection re-establishment is initiated, and is stopped upon selection of a suitable NR cell or selection of a cell using another radio access technology, and the expiration of the T311 timer triggers entry into RRC idle state.

In one embodiment, the T310 timer is started upon detection of a problem in the physical layer of a SpCell, such as the detection of a problem in the physical layer of the target SpCell.

In one embodiment, the T310 timer is stopped when a number of consecutive in-sync timers are received from a lower layer.

In one embodiment, a T310 timer for a source cell is stopped upon reception of the first signaling.

In one embodiment, a T310 timer for a source cell is stopped upon execution of the first signaling.

In one embodiment, a target cell group targeted by the reconfiguration WithSync included in the first signaling is a first cell group, and a SpCell of the first cell group is the target SpCell.

In one embodiment, a cell group targeted by the reconfiguration WithSync included in the first signaling is a cell group to which a source cell of the first node belongs.

In one subembodiment, the cell group targeted by the reconfiguration WithSync included in the first signaling is a source cell group.

In one subembodiment, the cell group targeted by the reconfiguration WithSync included in the first signaling is a cell group of a source cell.

In one embodiment, the first message is feedback for the first signaling.

In one embodiment, the first message appears in pairs with the first signaling.

In one embodiment, a complete switching procedure comprises executing the first signaling and transmitting the first message.

In one embodiment, the first message is an RRC message.

In one embodiment, the first message is uplink.

In one embodiment, the first message is an RRCReconfigurationComplete message.

In one embodiment, the name of the first message indicates that RRC reconfiguration is completed.

In one embodiment, the first message is an RRC reconfiguration complete message.

In one embodiment, the transmitting of the first message implies a successful completion of switching.

In one embodiment, the first message is transmitted via SRB1.

In one embodiment, the first message indicates that there is available information of successful switch.

In one embodiment, the first message indicates that a gap is required.

In one embodiment, the first message indicates a selected conditional reconfiguration.

In one embodiment, the first message indicates a selected configuration for conditional cell switch.

In one subembodiment, the selected configuration for conditional cell switch is the first signaling.

In one embodiment, the benefits of the above method include: it allows the network to better understand that the first node selects the first signaling in the condition-based LTM, which is conducive to grasping the information of conditional cell switch, and optimizing the cell switch; and unlike CHO, the condition-based LTM is effective in shortening the switching time.

In one embodiment, the first report comprises an uplink RRC message.

In one embodiment, the first report comprises a field including success in its name that indicates the information of the successful switch.

In one embodiment, the first report comprises a field including HO in its name that indicates the information of the successful switch.

In one embodiment, the first report comprises a field including report in its name that indicates the information of the successful switch.

In one embodiment, the first node generates the first report based on information stored in a first state variable.

In one subembodiment, the first state variable stores information related to a successful switch.

In one subembodiment, the first state variable is a VarSuccessHO-Report.

In one embodiment, an RRC message carrying the first report is a UEInformationResponse.

In one embodiment, the first report is or comprises a success HO-Report.

In one embodiment, the first measurement result comprises at least one of Reference Signal Received Power (RSRP), Reference Signal Receiving Quality (RSRQ) or SIGNAL-NOISE RATIO (SNR).

In one embodiment, which of the RSRP, RSRQ and SNR is included in the first measurement result or the second measurement result depends on which measurement results have been obtained by the first node, and how the first node performs measurements is prior art in this field.

In one embodiment, the second measurement result comprises at least one of RSRP, RSRQ and SNR.

In one embodiment, the first measurement result and the second measurement result both comprise RSRP, and/or both comprise RSRQ, and/or both comprise SNR.

In one embodiment, the above method has the advantage of providing the network with a clearer picture of how the source cell's quality changes, e.g. how the RSRP changes.

In one embodiment, the meaning of the sentence the first measurement result and the second measurement result being both for a source cell is or includes: a field for recording a source cell in the first report comprises the first measurement result and the second measurement result.

In one subembodiment, a name of the field for recording the source cell in the first report includes source and cell.

In one subembodiment, the field for recording the source cell in the first report is sourceCellInfo.

In one embodiment, the meaning of the sentence the first measurement result and the second measurement result being both for a source cell is or includes: a field for recording a measurement result of a source cell in the first report comprises the first measurement result and the second measurement result.

In one subembodiment, the field recording the source cell in the first report is sourceCellMeas.

In one embodiment, the meaning of the sentence the first measurement result and the second measurement result being both for a source cell is or includes: the first measurement result and the second measurement result are both measurement results of the source cell.

In one embodiment, the meaning of the sentence the first measurement result and the second measurement result being both for a source cell is or includes: the first measurement result and the second measurement result are both obtained based on a reference signal resource of the source cell.

In one embodiment, the meaning of the sentence the first measurement result and the second measurement result being both for a source cell is or includes: the first measurement result and the second measurement result are both measurement results based on an SSB of the source cell.

In one embodiment, the meaning of the sentence the first measurement result and the second measurement result being both for a source cell is or includes: the first measurement result and the second measurement result are both measurement results based on a channel state information-reference signal (CSI-RS) of the source cell.

In one embodiment, a most recent measurement result before execution of the first signaling is: a most recent measurement result before reception of the switching command.

In one embodiment, the switching command is a layer-3 (L3) switching command.

In one embodiment, the switching command is an LTM switching command.

In one embodiment, the first measurement result is a cell level measurement result.

In one embodiment, the second measurement result is a cell level measurement result.

In one embodiment, the second measurement result is a measurement result after execution of the first signaling.

In one embodiment, the target SpCell is a target PCell.

In one embodiment, the first message indicates that there is available information of successful switch.

In one embodiment, as a response to receiving a request for the information of the successful switch, the first node transmits the first report.

In one embodiment, the target SpCell is a target cell.

In one embodiment, the target SpCell is a target cell for switching.

In one embodiment, the first signaling indicates switching to the target SpCell.

In one embodiment, the first signaling indicates an RRC reconfiguration.

In one embodiment, the source cell is the transmitter of the first signaling.

In one embodiment, the meaning of the sentence the first measurement result is a most recent measurement result before executing the first signaling is or includes: the first measurement result comprises a last measurement result of all RSRP measurement results for the source cell prior to execution of the first signaling.

In one subembodiment, the first measurement result comprises at most one RSRP measurement result.

In one subembodiment, the phrase a last measurement result means a most recent measurement result, which is also the latest measurement result.

In one embodiment, the meaning of the sentence the first measurement result is a most recent measurement result before executing the first signaling is or includes: the first measurement result comprises a last measurement result of all RSRQ measurement results for the source cell prior to execution of the first signaling.

In one subembodiment, the first measurement result comprises at most one RSRQ measurement result.

In one subembodiment, the phrase a last measurement result means a most recent measurement result, which is also the latest measurement result.

In one embodiment, the meaning of the sentence the first measurement result is a most recent measurement result before executing the first signaling is or includes: the first measurement result comprises a last measurement result of all SNR measurement results for the source cell prior to execution of the first signaling.

In one subembodiment, the first measurement result comprises at most one SNR measurement result.

In one subembodiment, the phrase a last measurement result means a most recent measurement result, which is also the latest measurement result.

In one embodiment, the meaning of the sentence the second measurement result is a most recent measurement result before transmitting the first message is or includes: the second measurement result comprises a last measurement result of all RSRP measurement results for the source cell prior to transmitting the first message.

In one subembodiment, the second measurement result comprises at most one RSRP measurement result.

In one subembodiment, the phrase a last measurement result means a most recent measurement result, which is also the latest measurement result.

In one embodiment, the meaning of the sentence the second measurement result is a most recent measurement result before transmitting the first message is or includes: the second measurement result comprises a last measurement result of all RSRQ measurement results for the source cell prior to transmitting the first message.

In one subembodiment, the second measurement result comprises at most one RSRQ measurement result.

In one subembodiment, the phrase a last measurement result means a most recent measurement result, which is also the latest measurement result.

In one embodiment, the meaning of the sentence the second measurement result is a most recent measurement result before transmitting the first message is or includes: the second measurement result comprises a last measurement result of all SNR measurement results for the source cell prior to transmitting the first message.

In one subembodiment, the second measurement result comprises at most one SNR measurement result.

In one subembodiment, the phrase a last measurement result means a most recent measurement result, which is also the latest measurement result.

In one embodiment, the information of the successful switch comprises a third measurement result and a fourth measurement result, the third measurement result and the fourth measurement result being both for the target SpCell:
herein, the third measurement result is a most recent measurement result before executing the first signaling, while the fourth measurement result is a most recent measurement result before transmitting the first message.

In one embodiment, the third measurement result comprises at least one of RSRP, RSRQ and SNR.

In one embodiment, the fourth measurement result comprises at least one of RSRP, RSRQ and SNR.

In one embodiment, the third measurement result and the fourth measurement result both comprise RSRP, and/or both comprise RSRQ, and/or both comprise SNR.

In one embodiment, the above method has the advantage of providing the network with a clearer picture of how the target SpCell's quality changes, e.g. how the RSRP changes.

In one embodiment, the meaning of the sentence the third measurement result and the fourth measurement result being both for the target SpCell is or includes: a field for recording the target SpCell in the first report comprises the third measurement result and the fourth measurement result.

In one subembodiment, a name of the field for recording the target SpCell in the first report includes target and cell.

In one subembodiment, the field for recording the target SpCell in the first report is targetCellInfo.

In one embodiment, the meaning of the sentence the third measurement result and the fourth measurement result being both for the target SpCell is or includes: a field for recording measurement results of the target SpCell in the first report comprises the third measurement result and the fourth measurement result.

In one subembodiment, the field for recording the target SpCell in the first report is targetCellMeas.

In one embodiment, the meaning of the sentence the third measurement result and the fourth measurement result being both for the target SpCell is or includes: the third measurement result and the fourth measurement result are both measurement results of the target SpCell.

In one embodiment, the meaning of the sentence the third measurement result and the fourth measurement result being both for the target SpCell is or includes: the third measurement result and the fourth measurement result are both obtained based on a reference signal resource of the target SpCell.

In one embodiment, the meaning of the sentence the third measurement result and the fourth measurement result being both for the target SpCell is or includes: the third measurement result and the fourth measurement result are both measurement results based on an SSB of the target SpCell.

In one embodiment, the meaning of the sentence the third measurement result and the fourth measurement result being both for the target SpCell is or includes: the third measurement result and the fourth measurement result are both measurement results based on a channel state information-reference signal (CSI-RS) of the target SpCell.

In one embodiment, the meaning of the sentence the third measurement result is a most recent measurement result before executing the first signaling is or includes: the third measurement result comprises a last measurement result of all RSRP measurement results for the target SpCell prior to execution of the first signaling.

In one subembodiment, the third measurement result comprises at most one RSRP measurement result.

In one subembodiment, the phrase a last measurement result means a most recent measurement result, which is also the latest measurement result.

In one embodiment, the meaning of the sentence the third measurement result is a most recent measurement result before executing the first signaling is or includes: the third measurement result comprises a last measurement result of all RSRQ measurement results for the target SpCell prior to execution of the first signaling.

In one subembodiment, the third measurement result comprises at most one RSRQ measurement result.

In one subembodiment, the phrase a last measurement result means a most recent measurement result, which is also the latest measurement result.

In one embodiment, the meaning of the sentence the third measurement result is a most recent measurement result before executing the first signaling is or includes: the third measurement result comprises a last measurement result of all SNR measurement results for the target SpCell prior to execution of the first signaling.

In one subembodiment, the third measurement result comprises at most one SNR measurement result.

In one subembodiment, the phrase a last measurement result means a most recent measurement result, which is also the latest measurement result.

In one embodiment, the meaning of the sentence the fourth measurement result is a most recent measurement result before transmitting the first message is or includes: the fourth measurement result comprises a last measurement result of all RSRP measurement results for the target SpCell prior to transmitting the first message.

In one subembodiment, the fourth measurement result comprises at most one RSRP measurement result.

In one subembodiment, the phrase a last measurement result means a most recent measurement result, which is also the latest measurement result.

In one embodiment, the meaning of the sentence the fourth measurement result is a most recent measurement result before transmitting the first message is or includes: the fourth measurement result comprises a last measurement result of all RSRQ measurement results for the target SpCell prior to transmitting the first message.

In one subembodiment, the fourth measurement result comprises at most one RSRQ measurement result.

In one subembodiment, the phrase a last measurement result means a most recent measurement result, which is also the latest measurement result.

In one embodiment, the meaning of the sentence the fourth measurement result is a most recent measurement result before transmitting the first message is or includes: the fourth measurement result comprises a last measurement result of all SNR measurement results for the target SpCell prior to transmitting the first message.

In one subembodiment, the fourth measurement result comprises at most one SNR measurement result.

In one subembodiment, the phrase a last measurement result means a most recent measurement result, which is also the latest measurement result.

In one embodiment, the information of the successful switch comprises a third measurement result and a fourth measurement result, the third measurement result and the fourth measurement result being both for the target SpCell:
herein, the third measurement result is a most recent measurement result before executing the first signaling, while the fourth measurement result is a most recent measurement result before transmitting the first message.

In one embodiment, the information of the successful switch comprises an identity of the source cell and an identity of the target SpCell.

In one embodiment, the information of the successful switch indicates time for at least one measurement result.

In one subembodiment, the at least one measurement result includes at least one of the first measurement result, the second measurement result, the third measurement result, the fourth measurement result, the fifth measurement result or the sixth measurement result.

In one embodiment, the information of the successful switch indicates time for the first measurement result.

In one embodiment, the information of the successful switch indicates time for the second measurement result.

In one embodiment, the information of the successful switch indicates time for the third measurement result.

In one embodiment, the information of the successful switch indicates time for the fourth measurement result.

In one embodiment, the time for the measurement result refers to the time when the measurement result is generated.

In one embodiment, the time for the measurement result refers to a time stamp of the measurement result.

In one embodiment, the time for the measurement result refers to the time when the measurement result is obtained.

In one embodiment, the time for the measurement result refers to Coordinated Universal Time (UTC).

In one embodiment, the time for the measurement result refers to a time interval between obtaining the measurement result and the transmitting of the first report.

In one embodiment, the time for the measurement result refers to a time interval between obtaining the measurement result and the transmitting of the first message.

In one embodiment, the time for the measurement result refers to a time interval between the reception of the first signaling and the obtaining of the measurement result.

In one embodiment, the time for the measurement result refers to a time interval between the execution of the first signaling and the obtaining of the measurement result.

In one embodiment, the executing of the first signaling depends on a first measurement event being satisfied.

In one embodiment, the sentence that the executing of the first signaling depends on a first measurement event being satisfied means that the first signaling indicates or is used for conditional reconfiguration.

In one embodiment, the sentence that the executing of the first signaling depends on a first measurement event being satisfied means that the first signaling indicates or is used for conditional handover.

In one embodiment, the sentence that the executing of the first signaling depends on a first measurement event being satisfied means that the first signaling indicates or is used for condition-based cell switch.

In one embodiment, the information of the successful switch comprises a fifth measurement result and a sixth measurement result, the fifth measurement result and the sixth measurement result being both for a first reference signal resource for the source cell;
herein, the fifth measurement result is a most recent measurement result before executing the first signaling, while the sixth measurement result is a most recent measurement result before transmitting the first message.

In one embodiment, the first reference signal resource is an SSB.

In one embodiment, the first reference signal resource is a CSI-RS.

In one embodiment, the first reference signal resource is an SSB identified by an SSB index.

In one embodiment, the first reference signal resource is a CSI-RS identified by a CSI-RS index.

In one embodiment, the fifth measurement result comprises at least one of RSRP, RSRQ and SNR.

In one embodiment, the sixth measurement result comprises at least one of RSRP, RSRQ and SNR.

In one embodiment, the fifth measurement result and the sixth measurement result both comprise RSRP, and/or both comprise RSRQ, and/or both comprise SNR.

In one embodiment, the above method has the advantage of providing the network with a clearer picture of how the quality of the reference signal resource for the source cell changes, e.g. how the RSRP changes.

In one embodiment, the meaning of the sentence the fifth measurement result and the sixth measurement result being both for a first reference signal resource for the source cell is or includes: a field for recording the source cell in the first report comprises the fifth measurement result and the sixth measurement result.

In one subembodiment, a name of the field for recording the source cell in the first report includes source and cell.

In one subembodiment, the field for recording the source cell in the first report is sourceCellInfo.

In one embodiment, the meaning of the sentence the fifth measurement result and the sixth measurement result being both for a first reference signal resource for the source cell is or includes: a field for recording measurement results of the source cell in the first report comprises the fifth measurement result and the sixth measurement result.

In one subembodiment, the field for recording the source cell in the first report is sourceCellMeas.

In one embodiment, the meaning of the sentence the fifth measurement result and the sixth measurement result being both for a first reference signal resource for the source cell is or includes: the fifth measurement result and the sixth measurement result are both measurement results on the first reference signal resource for the source cell.

In one embodiment, the meaning of the sentence the fifth measurement result and the sixth measurement result being both for a first reference signal resource for the source cell is or includes: the fifth measurement result and the sixth measurement result are both obtained based on the first reference signal resource for the source cell.

In one embodiment, the meaning of the sentence the fifth measurement result and the sixth measurement result being both for a first reference signal resource for the source cell is or includes: the fifth measurement result and the sixth measurement result are both measurement results based on a first SSB for the source cell.

In one embodiment, the meaning of the sentence the fifth measurement result and the sixth measurement result being both for a first reference signal resource for the source cell is or includes: the fifth measurement result and the sixth measurement result are both measurement results based on a first channel state information-reference signal (CSI-RS) of the source cell.

In one embodiment, the meaning of the sentence the fifth measurement result and the sixth measurement result being both for a first reference signal resource for the source cell is or includes: the fifth measurement result comprises a last measurement result of all RSRP measurement results for the first reference signal resource for the source cell prior to execution of the first signaling.

In one subembodiment, the fifth measurement result comprises at most one RSRP measurement result for the first reference signal resource.

In one subembodiment, the phrase a last measurement result means a most recent measurement result, which is also the latest measurement result.

In one embodiment, the meaning of the sentence the fifth measurement result and the sixth measurement result being both for a first reference signal resource for the source cell is or includes: the fifth measurement result comprises a last measurement result of all RSRQ measurement results for the first reference signal resource for the source cell prior to execution of the first signaling.

In one subembodiment, the fifth measurement result comprises at most one RSRQ measurement result for the first reference signal resource.

In one subembodiment, the phrase a last measurement result means a most recent measurement result, which is also the latest measurement result.

In one embodiment, the meaning of the sentence the fifth measurement result and the sixth measurement result being both for a first reference signal resource for the source cell is or includes: the fifth measurement result comprises a last measurement result of all SNR measurement results for the first reference signal resource for the source cell prior to execution of the first signaling.

In one subembodiment, the fifth measurement result comprises at most one SNR measurement result for the first reference signal resource.

In one subembodiment, the phrase a last measurement result means a most recent measurement result, which is also the latest measurement result.

In one embodiment, the meaning of the sentence the sixth measurement result is a most recent measurement result before transmitting the first message is or includes: the sixth measurement result comprises a last measurement result of all RSRP measurement results for the first reference signal resource for the source cell prior to transmitting the first message.

In one subembodiment, the sixth measurement result comprises at most one RSRP measurement result for the first reference signal resource.

In one subembodiment, the phrase a last measurement result means a most recent measurement result, which is also the latest measurement result.

In one embodiment, the meaning of the sentence the sixth measurement result is a most recent measurement result before transmitting the first message is or includes: the sixth measurement result comprises a last measurement result of all RSRQ measurement results for the first reference signal resource for the source cell prior to transmitting the first message.

In one subembodiment, the sixth measurement result comprises at most one RSRQ measurement result for the first reference signal resource.

In one subembodiment, the phrase a last measurement result means a most recent measurement result, which is also the latest measurement result.

In one embodiment, the meaning of the sentence the sixth measurement result is a most recent measurement result before transmitting the first message is or includes: the sixth measurement result comprises a last measurement result of all SNR measurement results for the first reference signal resource for the source cell prior to transmitting the first message.

In one subembodiment, the sixth measurement result comprises at most one SNR measurement result for the first reference signal resource.

In one subembodiment, the phrase a last measurement result means a most recent measurement result, which is also the latest measurement result.

In one embodiment, the measurement results for a cell are different from the measurement results for a certain reference signal resource, and the above method is advantageous in that it allows the network to have more detailed measurement results for the first reference signal resource at the time of triggering a switch, which is beneficial for optimizing the switch, e.g., the network can make use of the measurement results to configure a reasonable reference signal resource for the users at the edge of the cell.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, a base station of the second node in the present application is the gNB 203.

In one embodiment, a radio link from the UE 201 to the NR Node B is an uplink.

In one embodiment, a radio link from the NR Node B to the UE 201 is a downlink.

In one embodiment, the UE 201 includes cellphone.

In one embodiment, the UE 201 is a means of transportation including automobile.

In one embodiment, the gNB 203 is a MacroCellular base station.

In one embodiment, the gNB 203 is a Micro Cell base station.

In one embodiment, the gNB 203 is a Pico Cell base station.

In one embodiment, the gNB 203 is a flight platform.

In one embodiment, the gNB 203 is satellite equipment.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 used for a first node (UE, gNB) and a second node (gNB, UE), or between two UEs, is represented by three layers, which are layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second node and the first node. The PC5 Signaling (PC5-S) Protocol sublayer 307 is responsible for the signaling protocol processing of the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. SRBs can be viewed as services or interfaces provided by the PDCP layer to higher layers, such as the RRC layer. In NR systems SRBs include SRB1, SRB2, and SRB3, which are respectively used to transmit different types of control signaling. The SRB is a bearer between the UE and an access network and is used to transmit control signalings, including RRC signaling, between the UE and the access network. SRB1 has special significance for UEs. After each UE establishes an RRC connection, it will have a SRB1 for transmitting RRC signaling, and most of the signalings are transmitted through SRB1. If SRB1 is interrupted or unavailable, the UE has to carry out RRC re-establishment. SRB2 is generally only used to transmit NAS signaling or signaling related to security. The UE does not have to configure SRB3. Unless for urgent traffics, the UE must establish an RRC connection with the network to proceed with communications. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the second signaling in the present application is generated by the MAC 302.

In one embodiment, the first message in the present application is generated by the RRC 306.

In one embodiment, the first report in the present application is generated by the RRC 306.

In one embodiment, the first request information in the present application is generated by the RRC 306.

### Embodiment 4

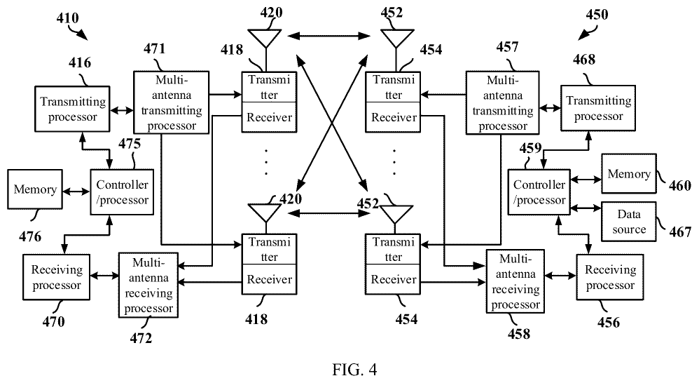

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data: the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data: the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory: The at least one memory comprises computer program codes: the at least one memory and the computer program codes are configured to be used in collaboration with the at least one processor. The first communication device 450 at least executes a first signaling, the first signaling configuring a target SpCell; and transmits a first message as a response to successfully executing the first signaling, the first message indicating completion of an RRC reconfiguration; and transmits a first report, the first report comprising information of a successful switch: the information of the successful switch comprising at least a former of a first measurement result and a second measurement result, the first measurement result and the second measurement result being both for a source cell: herein, the first measurement result is a most recent measurement result before executing the first signaling, while the second measurement result is a most recent measurement result before transmitting the first message.

In one embodiment, the first communication device 450 comprises a memory that stores a computer readable instruction program. The computer readable instruction program generates actions when executed by at least one processor. The actions include: executing a first signaling, the first signaling configuring a target SpCell; and transmitting a first message as a response to successfully executing the first signaling, the first message indicating completion of an RRC reconfiguration; and transmitting a first report, the first report comprising information of a successful switch: the information of the successful switch comprising at least a former of a first measurement result and a second measurement result, the first measurement result and the second measurement result being both for a source cell: herein, the first measurement result is a most recent measurement result before executing the first signaling, while the second measurement result is a most recent measurement result before transmitting the first message.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a vehicle-mounted terminal.

In one embodiment, the first communication device 450 is a cellphone.

In one embodiment, the second communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used for receiving the first signaling in the present application.

In one embodiment, the receiver 454 (comprising the antenna 452), the receiving processor 456 and
the controller/processor 459 are used for receiving the second signaling in the present application.

In one embodiment, the receiver 454 (comprising the antenna 452), the receiving processor 456 and the controller/processor 459 are used for receiving the first request information in the present application.

In one embodiment, the transmitter 454 (comprising the antenna 452), the transmitting processor 468 and the controller/processor 459 are used for transmitting the first message in the present application.

In one embodiment, the transmitter 454 (comprising the antenna 452), the transmitting processor 468 and the controller/processor 459 are used for transmitting the first report in the present application.

### Embodiment 5

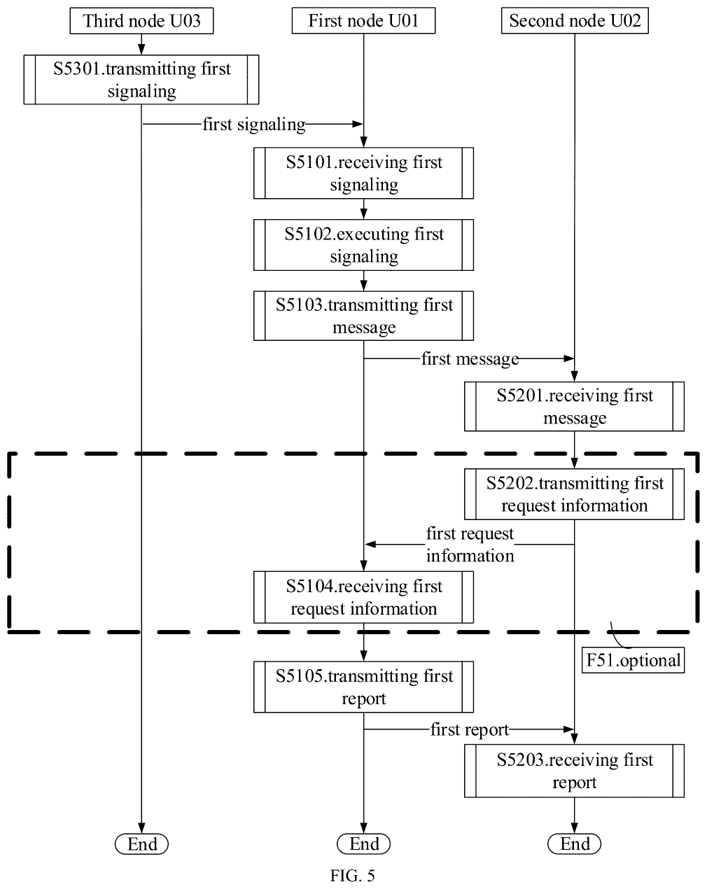

Embodiment 5 illustrates a flowchart of radio signal transmission according to one embodiment of the present application, as shown in FIG. 5. In FIG. 5, U01 corresponds to a first node in the present application, U02 corresponds to a target SpCell in the present application, and U03 corresponds to a source cell in the present application. It should be particularly noted that the order presented in this embodiment does not limit the order of signal transmissions or the order of implementations of the present application: where steps marked by the F51 are optional.

The first node U01 receives a first signaling in step S5101: executes a first signaling in step S5102; transmits a first message in step S5103: receives first request information in step S5104; and transmits a first report in step S5105.

The second node U02 receives a first message in step S5201; transmits first request information in step S5202; and receives a first report in step S5203.

The third node U03 transmits a first signaling in step S5301.

In Embodiment 5, executing a first signaling, the first signaling configuring a target Special Cell (SpCell);
transmitting a first message as a response to successfully executing the first signaling, the first message indicating completion of a Radio Resource Control (RRC) reconfiguration; and
transmitting a first report, the first report comprising information of a successful switch; the information of the successful switch comprising at least a former of a first measurement result and a second measurement result, the first measurement result and the second measurement result being both for a source cell;
herein, the first measurement result is a most recent measurement result before executing the first signaling, while the second measurement result is a most recent measurement result before transmitting the first message.

In one embodiment, the second node U02 is a base station corresponding to the target SpCell.

In one embodiment, the third node U03 is a base station corresponding to the source cell.

In one embodiment, the first node U01 switches from the third node U03 to the second node U02.

In one embodiment, the third node U03 and the second node U02 belong to a same control unit (CU).

In one embodiment, the third node U03 and the second node U02 belong to a same data unit (DU).

In one embodiment, the third node U03 and the second node U02 belong to a same public land mobile network (PLMN).

In one embodiment, the third node U03 and the second node U02 use the same wireless access technology.

In one embodiment, the third node U03 and the second node U02 use different wireless access technologies.

In one embodiment, the third node U03 and the second node U02 both belong to the NR network.

In one embodiment, the third node U03 and the second node U02 respectively belong to the EUTRAN network and the NR network, or vice versa.

In one embodiment, the second node U02 is a PSCell of the first node U01.

In one subembodiment, the PSCell of the first node U01 becomes the PCell of the first node U01.

In one embodiment, the second node U02 is a neighboring cell of the first node U01.

In one embodiment, the second node U02 is a neighboring cell of the first node U01 without being switched, or when not executing the first signaling.

In one embodiment, the step S5101 is before the step S5102.

In one embodiment, the step S5102 is before the step S5103.

In one embodiment, the step S5103 is before the step S5104.

In one embodiment, the step S5104 is before the step S5105.

In one embodiment, receiving the signaling is prior art in this field.

In one embodiment, all steps in the attached FIG. 5 occur after an RRC connection has been established.

In one embodiment, when the first signaling is not carried by other RRC messages and spCellConfig included in the first signaling includes reconfiguration WithSync and the spCellConfig included in the first signaling configures the target SpCell, the first signaling is immediately executed upon reception.

In one subembodiment, the phrase that the first signaling is not carried by other RRC messages means that it is not the other RRC messages that encapsulate the first signaling.

In one subembodiment, the phrase that the first signaling is not carried by other RRC messages means that it is a DL-DCCH-Message that encapsulates the first signaling.

In one subembodiment, the phrase that the first signaling is not carried by other RRC messages means that the first signaling is a DL-DCCH-Message.

In one embodiment, the first signaling is an RRCReconfiguration, and the first signaling is carried by another RRCReconfiguration, when spCellConfig in the first signaling includes reconfiguration WithSync and the spCellConfig in the first signaling configures the target SpCell, the first signaling is not automatically executed immediately upon reception.

In one subembodiment, the phrase that the first signaling is not carried by other RRC messages means that it is not a DL-DCCH-Message that encapsulates the first signaling.

In one subembodiment, the phrase that the first signaling is not carried by other RRC messages means that the first signaling is not a DL-DCCH-Message.

In one subembodiment, the phrase that the first signaling is not carried by other RRC messages means that it is the other RRC messages that encapsulate the first signaling.

In one subembodiment, the execution of the first signaling is later than the reception of the first signaling.

In one embodiment, when the execution of the first signaling depends on a first measurement event being satisfied, the first signaling is not executed immediately upon reception.

In one subembodiment, the first signaling is first stored when received.

In one subembodiment, the first measurement event is an event associated with the first signaling.

In one subembodiment, the first signaling is executed on the condition that the first measurement event is satisfied.

In one subembodiment, the first signaling is used for a CHO or a conditional LTM.

In one embodiment, transmitting of the first message confirms that the first node U01 has switched to the second node U02.

In one embodiment, ue-MeasurementsAvailable in the first message indicates that there is available information of a successful switch.

In one embodiment, successHO-InfoAvailable-in the ue-MeasurementsAvailable in the first message indicates that there is available information of a successful switch.

In one embodiment, the first report is sent unsolicited.

In one embodiment, the first report is sent upon request.

In one embodiment, the first request information is an RRC message.

In one embodiment, the first request information requests the first report.

In one embodiment, a successHO-ReportReq included in the first request information indicates a request for the successful switch.

In one embodiment, the first request information is a UEInformationRequest.

In one embodiment, the first request information comprises at least part of fields in the UEInformationRequest.

In one embodiment, as a response to receiving the first request information, the first node U01 transmits the first report.

In one embodiment, the first report comprises first location information.

In one subembodiment, the first location information is location information at the time of execution of the first signaling.

In one subembodiment, the first location information is the most recent location information prior to execution of the first signaling.

In one subembodiment, the first location information comprises at least one of a timestamp or a geographic location.

In one embodiment, the first report comprises second location information.

In one subembodiment, the second location information is location information at the time of transmission of the first message.

In one subembodiment, the second location information is the most recent location information prior to transmission of the first message.

In one subembodiment, the second location information comprises at least one of a timestamp or a geographic location.

In one embodiment, the first report includes a reason for the information of successful switch.

In one embodiment, the first report includes random access information.

In one embodiment, the first report includes an interruption time of the switching.

In one embodiment, the first report includes an identity of the first node.

In one embodiment, the first report includes a time interval between initiating a last conditional reconfiguration execution for the target SpCell and receiving the last conditional reconfiguration.

In one embodiment, the first signaling is transmitted to the first node U01 by the third node U03, but the generator of the first signaling is the second node U02, and the second node U02 firstly transmits the first signaling to the third node U03.

In one subembodiment, the first signaling is a conditional reconfiguration signaling.

### Embodiment 6

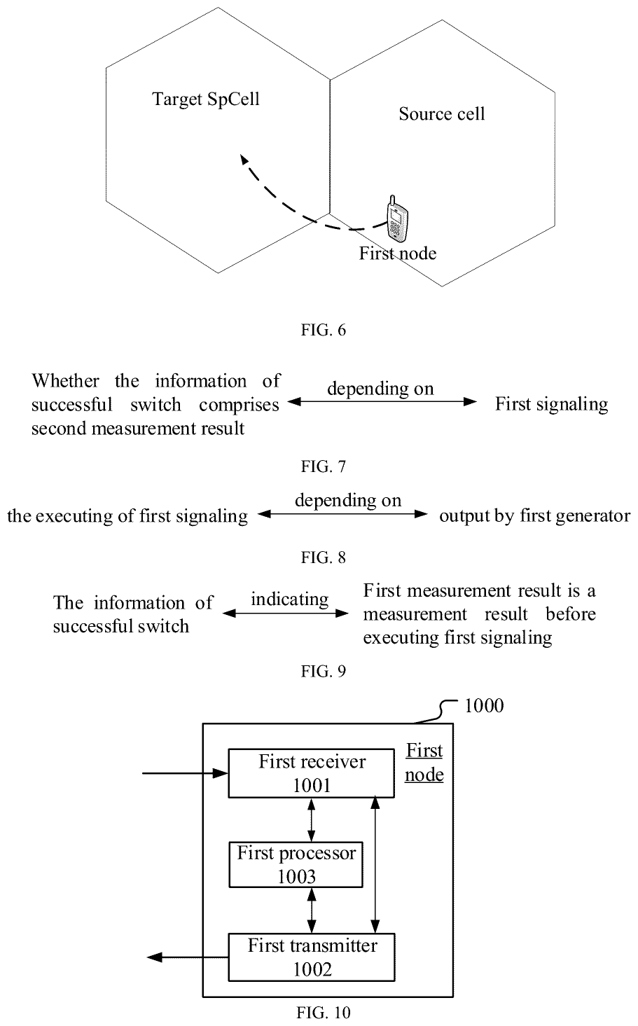

Embodiment 6 illustrates a schematic diagram of switching according to one embodiment of the present application, as shown in FIG. 6.

In one embodiment, FIG. 6 attached illustrates the first node switching from a source cell to the target SpCell, the dashed lines in FIG. 6 illustrates the direction in which the first node switches, and the method proposed in the present application does not require the first node to move in accordance with the dashed lines as provided in FIG. 6.

In one embodiment, the source cell is a transmitter of the first signaling.

In one embodiment, the source cell and the target SpCell either belong to an MCG or belong to an SCG, respectively:

In one embodiment, the source cell is a PCell and the target SpCell is a target PCell.

In one embodiment, the source cell is a PSCell and the target SpCell is a target PSCell.

In one embodiment, in a switching scenario, the first node switches from one cell to another, the one cell is a source cell while the other cell is a target cell, and the target cell corresponds to the target SpCell of the present application.

In one embodiment, the source cell and the target SpCell both refer in this field to the cell in switch.

In one embodiment, the first signaling indicates a conditional reconfiguration.

In one subembodiment, the conditional reconfiguration is a conditional switch.

In one subembodiment, the condition associated with the conditional reconfiguration is that the first measurement event is satisfied.

In one subembodiment, after the first measurement event is satisfied, the first node may decide on its own when to execute the first signaling.

In one subembodiment, the first node decides when to execute the first signaling based on the output of a first generator or the L1 measurement result.

In one subembodiment, the above method is advantageous in that the first node, after the first measurement event has been satisfied, which is a most conservative condition, can determine on its own the optimal time for switching according to the condition of a wireless channel, which makes the performance of the switching further optimized.

In one subembodiment, the above method is advantageous in that since the network cannot accurately know the channel quality at the time of triggering the switch, including the measurement result of the source cell, the information of the successful switch, including the first measurement result, is of extra significance.

In one embodiment, the first signaling comprises RRC reconfiguration.

In one subembodiment, the first node determines on its own when to execute the first signaling.

In one subembodiment, the first node may determine when to execute the first signaling based on implementation within a time window.

In one subembodiment, the first node may decide when to execute the first signaling based on an output of the first generator or an L1 measurement result.

In one subembodiment, the above method is advantageous in that when to trigger the switching is entirely determined by the first node, enabling the first node to determine the optimal time for switching on its own based on the condition of a wireless channel, which enables further optimization of the performance of the switching, and is particularly suitable for artificial intelligence-enabled terminals and/or mobility management in the network.

In one subembodiment, the above method is advantageous in that since the network cannot accurately know the channel quality at the time of triggering the switch, including the measurement result of the source cell, the information of the successful switch, including the first measurement result, is of extra significance.

### Embodiment 7

Embodiment 7 illustrates a schematic diagram of whether the information of successful switch comprises a second measurement result depending on a first signaling according to one embodiment of the present application, as shown in FIG. 7.

In one embodiment, the information of successful switch always includes the second measurement result, and when the first node does not obtain a measurement result for the source cell that is later than the first measurement result, the second measurement result is equal to the first measurement result.

In one embodiment, when the first node does not obtain a measurement result for the source cell that is later than the first measurement result, the information of successful switch does not include the second measurement result.

In one embodiment, when the first node obtains a measurement result for the source cell that is later than the first measurement result, the information of successful switch includes the second measurement result.

In one embodiment, the first signaling indicates whether the second measurement result is included.

In one embodiment, when the target SpCell configured by the first signaling and the source cell belong to a same frequency range, the information of successful switch includes the second measurement result, otherwise, the information of successful switch does not include the second measurement result.

In one subembodiment, the first node obtains a measurement result for the source cell later than the first measurement result.

In one subembodiment, the target SpCell is an intra-frequency cell relative to the source cell.

In one subembodiment, the first node is not capable of measuring the inter-frequency cell.

In one embodiment, whether the information of the successful switch comprises the second measurement result depends on a measurement configuration included in the first signaling.

In one subembodiment, when a measurement object configured by the first signaling includes a measurement for the source cell, the information of successful switch includes the second measurement result.

In one subembodiment, when a measurement object configured by the first signaling does not include a measurement for the source cell, the information of successful switch does not include the second measurement result.

In one embodiment, whether the information of the successful switch comprises the second measurement result depends on the target SpCell configured by the first signaling.

In one subembodiment, when the target SpCell configured by the first signaling and the source cell belong to a same DU, the information of the successful switch includes the second measurement result, otherwise, the information of the successful switch does not include the second measurement result.

In one subembodiment, when the target SpCell configured by the first signaling and the source cell belong to a same CU, the information of the successful switch includes the second measurement result, otherwise, the information of the successful switch does not include the second measurement result.

In one subembodiment, when the target SpCell configured by the first signaling and the source cell belong to a same cell group, for instance an MCG, the information of the successful switch includes the second measurement result, otherwise, the information of the successful switch does not include the second measurement result

In one embodiment, when the source cell becomes a PSCell of the first node after execution of the first signaling, the information of successful switch includes the second measurement result.

In one embodiment, when the source cell does not become a PSCell of the first node after execution of the first signaling, the information of successful switch does not include the second measurement result.

In one embodiment, the execution of the first signaling enables a switch between the PCell and the PSCell.

In one embodiment, when the target SpCell configured by the first signaling is synchronized with the source cell, the information of successful switch includes the second measurement result.

In one subembodiment, the target SpCell being synchronized with the source cell means that the target SpCell is synchronized with the source cell prior to switching.

In one embodiment, when the target SpCell configured by the first signaling is not synchronized with the source cell, the information of successful switch includes the second measurement result.

In one subembodiment, the target SpCell not being synchronized with the source cell means that the target SpCell is not synchronized with the source cell prior to or at the time of switching.

In one embodiment, when the first node continues to measure the source cell after executing the first signaling, the information of successful switch includes the second measurement result.

In one subembodiment, prior to the first message, the first node obtains a measurement result for the source cell that is later than the first measurement result.

### Embodiment 8

Embodiment 8 illustrates a schematic diagram of the executing of a first signaling depending on an output by a first generator according to one embodiment of the present application, as shown in FIG. 8.

In one embodiment, the first generator is related to artificial intelligence.

In one embodiment, the first generator is related to machine learning.

In one embodiment, the first generator is related to neural networks.

In one embodiment, the first generator is used for prediction.

In one embodiment, the first generator is a neural network.

In one embodiment, the first generator is a function of machine learning.

In one embodiment, for a parameter of an output by the first generator, the execution of the first signaling is triggered when the parameter is greater than a specific threshold.

In one subembodiment, the parameter is used to measure a success rate of switching.

In one subembodiment, the parameter is used to average a throughput rate.

In one embodiment, for another parameter of an output by the first generator, the execution of the first signaling is triggered when the other parameter is less than another specific threshold.

In one subembodiment, the other parameter is used to measure a failure probability of switching.

In one subembodiment, the other parameter is used to measure an interruption time.

In one subembodiment, the execution of the first signaling implies execution of switching.

In one subembodiment, the first node determines the specific threshold based on an internal implementation.

In one subembodiment, the network configuration determines the specific threshold.

In one embodiment, the output of the first generator is a predicted quality of the target SpCell.

In one subembodiment, the prediction is to predict the quality of the target SpCell after time t1.

In one subembodiment, the t1 is a finite positive number, e.g., 10 milliseconds, 20 milliseconds, 40 milliseconds.

In one subembodiment, the t1 is determined by the first node according to an internal algorithm.

In one subembodiment, the t1 is determined according to the movement speed of the first node, the higher the movement speed, the shorter the t1 is.

In one subembodiment, the t1 is configured by the network.

In one subembodiment, the first signaling is executed when the predicted quality of the target SpCell is better than a first target threshold.

In one subembodiment, the first signaling is executed when the predicted quality of the target SpCell is better than a second target threshold for the quality of the source cell or better than a second target threshold for the predicted quality of the source cell.

In one subembodiment, the first signaling is executed when the predicted quality of the target SpCell is better than a first target threshold and the quality of the source cell or the predicted quality of the source cell is worse than a third target threshold.

In one subembodiment, the first target threshold, the second target threshold and the third target threshold may be determined by the first node according to an internal algorithm or configured by the network.

### Embodiment 9

Embodiment 9 illustrates a schematic diagram of the information of successful switch indicating that a first measurement result is a measurement result before executing a first signaling according to one embodiment of the present application, as shown in FIG. 9.

In one embodiment, the information of the successful switch explicitly indicates that the first measurement result is a measurement result before executing the first signaling.

In one embodiment, the information of the successful switch explicitly indicates that the first measurement result is a most recent measurement result before executing the first signaling.

In one embodiment, the value of a first measurement result field included in the information of successful switch comprises the first measurement result, the name of the first measurement result field indicating that the first measurement result is a measurement result before executing the first signaling.

In one embodiment, the value of a first measurement result field included in the information of successful switch comprises the first measurement result, the name of the first measurement result field indicating that the first measurement result is a most recent measurement result before executing the first signaling.

In one embodiment, the information of the successful switch indicates time information of the first measurement result and time information of execution of the first signaling, the time information of the first measurement result and the time information of execution of the first signaling indicating that the first measurement result is a measurement result before executing the first signaling.

### Embodiment 10

Embodiment 10 illustrates a structure block diagram of a processing device used in a first node according to one embodiment of the present application, as shown in FIG. 10. In FIG. 10, a processing device 1000 in the first node comprises a first receiver 1001, a first transmitter 1002 and a first processor 1003.

In Embodiment 10, the first processor 1003 executes a first signaling, the first signaling configuring a target SpCell:
the first transmitter 1002 transmits a first message as a response to successfully executing the first signaling, the first message indicating completion of an RRC reconfiguration; and
the first transmitter 1002 transmits a first report, the first report comprising information of a successful switch; the information of the successful switch comprising at least a former of a first measurement result and a second measurement result, the first measurement result and the second measurement result being both for a source cell;
herein, the first measurement result is a most recent measurement result before executing the first signaling, while the second measurement result is a most recent measurement result before transmitting the first message.

In one embodiment, whether the information of the successful switch comprises the second measurement result depends on the first signaling.

In one embodiment, the information of the successful switch comprises a third measurement result and a fourth measurement result, the third measurement result and the fourth measurement result being both for the target SpCell: where the third measurement result is a most recent measurement result before executing the first signaling, while the fourth measurement result is a most recent measurement result before transmitting the first message.

In one embodiment, the information of the successful switch indicates time for at least one measurement result.

In one embodiment, the executing of the first signaling depends on a first measurement event being satisfied.

In one embodiment, the first receiver 1001 receives a second signaling, the second signaling triggering the action of executing the first signaling, the second signaling being a control signaling at a MAC layer, the second signaling indicating the target SpCell.

In one embodiment, the executing of the first signaling depends on an output by a first generator, the first generator being training-based.

In one embodiment, the information of the successful switch indicates that the first measurement result is a measurement result before executing the first signaling.

In one embodiment, the information of the successful switch comprises at least a former of a fifth measurement result and a sixth measurement result, the fifth measurement result and the sixth measurement result being both for a first reference signal resource for the source cell:
herein, the fifth measurement result is a most recent measurement result before executing the first signaling, while the sixth measurement result is a most recent measurement result before transmitting the first message.

In one embodiment, the first node is a UE.

In one embodiment, the first node is a terminal supporting large delay difference.

In one embodiment, the first node is a terminal supporting NTN.

In one embodiment, the first node is an aircraft or vessel.

In one embodiment, the first node is a cellphone or vehicle-mounted terminal.

In one embodiment, the first node is a terminal supporting MUSIM.

In one embodiment, the first node is an IoT terminal or IIoT terminal.

In one embodiment, the first node is a piece of equipment supporting transmissions with low delay and high reliability.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first processor, executing a first signaling, the first signaling configuring a target Special Cell (SpCell); and
a first transmitter, transmitting a first message as a response to successfully executing the first signaling, the first message indicating completion of a Radio Resource Control (RRC) reconfiguration;
the first transmitter, transmitting a first report, the first report comprising information of a successful switch; the information of the successful switch comprises at least a former of a first measurement result and a second measurement result, the first measurement result and the second measurement result being both for a source cell;
wherein the first measurement result is a most recent measurement result before executing the first signaling, while the second measurement result is a most recent measurement result before transmitting the first message.

2. The first node according to claim 1, characterized in that
whether the information of the successful switch comprises the second measurement result depends on the first signaling.

3. The first node according to claim 1, characterized in that
the information of the successful switch comprises at least a former of a third measurement result and a fourth measurement result, the third measurement result and the fourth measurement result being both for the target SpCell;
wherein the third measurement result is a most recent measurement result before executing the first signaling, while the fourth measurement result is a most recent measurement result before transmitting the first message.

4. The first node according to claim 2, characterized in that
the information of the successful switch comprises at least a former of a third measurement result and a fourth measurement result, the third measurement result and the fourth measurement result being both for the target SpCell;
wherein the third measurement result is a most recent measurement result before executing the first signaling, while the fourth measurement result is a most recent measurement result before transmitting the first message.

5. The first node according to claim 1, characterized in that
the information of the successful switch indicates time for at least one measurement result.

6. The first node according to claim 1, characterized in that
the executing of the first signaling depends on a first measurement event being satisfied.

7. The first node according to claim 2, characterized in that
the executing of the first signaling depends on a first measurement event being satisfied.

8. The first node according to claim 3, characterized in that
the executing of the first signaling depends on a first measurement event being satisfied.

9. The first node according to claim 6, characterized in that
the first measurement event is one of or a combination of multiple of CondEvent A3, CondEvent A4, CondEvent A5, CondEvent T1, and CondEvent L1.

10. The first node according to claim 7, characterized in that
the first measurement event is one of or a combination of multiple of CondEvent A3, CondEvent A4, CondEvent A5, CondEvent T1, and CondEvent L1.

11. The first node according to claim 8, characterized in that
the first measurement event is one of or a combination of multiple of CondEvent A3, CondEvent A4, CondEvent A5, CondEvent T1, and CondEvent L1.

12. The first node according to claim 1, characterized in comprising:
a first receiver, receiving a second signaling, the second signaling triggering the executing of the first signaling, the second signaling being a control signaling at a MAC layer, the second signaling indicating the target SpCell.

13. The first node according to claim 1, characterized in that
the executing of the first signaling depends on an output by a first generator, the first generator being training-based.

14. The first node according to claim 2, characterized in that
the executing of the first signaling depends on an output by a first generator, the first generator being training-based.

15. The first node according to claim 3, characterized in that
the executing of the first signaling depends on an output by a first generator, the first generator being training-based.

16. The first node according to claim 9, characterized in that
the executing of the first signaling depends on an output by a first generator, the first generator being training-based.

17. The first node according to claim 1, characterized in that
the information of the successful switch indicates that the first measurement result is a measurement result before executing the first signaling.

18. The first node according to claim 1, characterized in that
the information of the successful switch comprises at least a former of a fifth measurement result and a sixth measurement result, the fifth measurement result and the sixth measurement result being both for a first reference signal resource for the source cell;
wherein the fifth measurement result is a most recent measurement result before executing the first signaling, while the sixth measurement result is a most recent measurement result before transmitting the first message.

19. A method in a first node for wireless communications, comprising:
executing a first signaling, the first signaling configuring a target Special Cell (SpCell);
transmitting a first message as a response to successfully executing the first signaling, the first message indicating completion of a Radio Resource Control (RRC) reconfiguration; and
transmitting a first report, the first report comprising information of a successful switch; the information of the successful switch comprises at least a former of a first measurement result and a second measurement result, the first measurement result and the second measurement result being both for a source cell;
wherein the first measurement result is a most recent measurement result before executing the first signaling, while the second measurement result is a most recent measurement result before transmitting the first message.

20. The method in the first node according to claim 19, characterized in that
the information of the successful switch comprises at least a former of a third measurement result and a fourth measurement result, the third measurement result and the fourth measurement result being both for the target SpCell;
wherein the third measurement result is a most recent measurement result before executing the first signaling, while the fourth measurement result is a most recent measurement result before transmitting the first message.
